(19) United States
(12) Patent Application Publication
(10) Pub. No.: US 2026/0189793 A1
(43) Pub. Date: Jul. 2, 2026

(54) CONTROL DEVICE, CONTROL METHOD, AND CONTROL PROGRAM

(71) Applicant: FUJIFILM Corporation, Tokyo (JP)

(72) Inventors: Tomoharu SHIMADA, Saitama-shi (JP); Tetsuya FUJIKAWA, Saitama-shi (JP); Masahiko SUGIMOTO, Saitama-shi (JP)

(73) Assignee: FUJIFILM Corporation, Tokyo (JP)

(21) Appl. No.: 19/548,955

(22) Filed: Feb. 25, 2026

Related U.S. Application Data
(63) Continuation of application No. PCT/JP2024/029246, filed on Aug. 19, 2024.

(30) Foreign Application Priority Data
Aug. 28, 2023 (JP) 2023-138033
Oct. 16, 2023 (JP) 2023-178219

(51) Int. Cl. H04N 23/695; H04N 23/61

(52) U.S. Cl. CPC H04N 23/695; H04N 23/61

(57) ABSTRACT

A control device is included in an imaging system including an imaging apparatus, a pan-tilt device that is controlled based on a result of analysis of a captured image captured by the imaging apparatus to cause the imaging apparatus to pan and tilt, and a distance measurement device. The control device includes a processor. The processor is configured to set a range of the analysis for detecting a specific object in the captured image based on information on a distance of the specific object acquired from the distance measurement device and at least one of information on a size of the specific object or information on a speed of the specific object.

### CROSS-REFERENCE TO RELATED APPLICATIONS

This is a continuation of International Application No. PCT/JP2024/029246 filed on Aug. 19, 2024, and claims priority from Japanese Patent Application No. 2023-138033 filed on Aug. 28, 2023 and Japanese Patent Application No. 2023-178219 filed on Oct. 16, 2023, the entire content of which is incorporated herein by reference.

### BACKGROUND OF THE INVENTION

### 1. Field of the Invention

The present invention relates to a control device, a control method, and a storage medium.

### 2. Description of the Related Art

JP2010-136095A discloses a tracking imaging apparatus comprising: an imaging unit that captures an image in a direction of an imaging optical axis; a driving unit that drives the imaging unit to change the direction of the imaging optical axis in order to track a target object in the image to be imaged; a region setting unit that sets a detection processing region in a partial region of the captured image; and an object position detection unit that processes an image of the set detection processing region to detect position information of the target object in the detection processing region, in which the region setting unit sets the detection processing region in a next imaging based on the detected position information of the target object.

WO2019/093297A discloses an information processing apparatus that detects a moving object with a sensor, specifies a first direction from the sensor toward the moving object, causes a camera to perform imaging while moving an optical axis direction of the camera along the first direction, and detects the moving object by performing image analysis on a captured image.

JP2017-046321A discloses a control device that records a size of a tracking target shown in a captured video captured by an imaging apparatus, determines a predicted size of the tracking target in a zoomed-out captured video after zooming out at a predetermined magnification based on the recorded size in a case in which a state in which the tracking target can be detected from the captured video changes to a state in which the tracking target cannot be detected, and zooms out at the predetermined magnification in a case in which the predicted size is larger than a predetermined size, and searches for the tracking target from the zoomed-out captured video.

JP2017-228492A discloses an image processing apparatus that automatically controls a zoom magnification in a case in which a movement of an object is detected from an input image such that the object does not go out of a field of view.

### SUMMARY OF THE INVENTION

One embodiment according to the disclosed technology provides a control device, a control method, and a storage medium capable of improving a tracking performance for a subject.
(1)

A control device that is included in an imaging system including an imaging apparatus, a pan-tilt device that is controlled based on a result of analysis of a captured image captured by the imaging apparatus to cause the imaging apparatus to pan and tilt, and a distance measurement device, the control device comprising:
a processor,
in which the processor is configured to set a range of the analysis in the captured image based on information on a distance of a specific object acquired from the distance measurement device and at least one of information on a size of the specific object or information on a speed of the specific object.
(2)

The control device according to (1),
in which the specific object is a specific subject included in the captured image.
(3)

The control device according to (1) or (2),
in which the processor is configured to perform the analysis.
(4)

The control device according to any one of (1) to (3),
in which the processor is configured to control the pan-tilt device based on the result of the analysis.
(5)

The control device according to any one of (1) to (4),
in which the distance measurement device is a device that acquires information on a direction.
(6)

The control device according to any one of (1) to (5),
in which the distance measurement device is a radar.
(7)

The control device according to (5) or (6),
in which the processor is configured to:
   control the pan-tilt device based on a detection result of the specific object by the analysis; and
   control the pan-tilt device based on the information on the direction in a case in which the detection result satisfies a first condition.
(8)

The control device according to (7),
in which the first condition is a condition regarding whether the specific object is detected.
(9)

The control device according to (8),
in which the first condition is a condition in which the specific object is not detected.
(10)

The control device according to any one of (1) to (9),
in which the processor is configured to set the range of the analysis based on a first range in the captured image based on the information on the distance of the specific object and the information on the size of the specific object and a second range in the captured image based on the information on the distance of the specific object and the information on the speed of the specific object.
(11)

The control device according to (10),
in which the processor is configured to set a range narrower than the first range and wider than the second range as the range of the analysis.
(12)

The control device according to (11),
in which the processor is configured to set the first range as the range of the analysis in a case in which the first range is narrower than the second range.
(13)

The control device according to any one of (1) to (12),
in which a focal length of the imaging apparatus is variable, and
the processor is configured to control the focal length based on the range of the analysis.
(14)

The control device according to (13),
in which the processor is configured to control the focal length such that an imaging range of the imaging apparatus is wider than the range of the analysis.
(15)

The control device according to any one of (1) to (14),
in which the processor is configured to display, on a display device, an image obtained by trimming the captured image based on the result of the analysis.
(16)

The control device according to (15),
in which the processor is configured to, in a case in which the specific object is not detected by the analysis, release the trimming and display the captured image on the display device.
(17)

The control device according to any one of (1) to (16),
in which the processor is configured to perform a notification to a user in a case in which the specific object is not detected by the analysis.
(18)

The control device according to any one of (1) to (17),
in which the processor is configured to select a mode of the analysis from among a plurality of analysis modes based on the information on the distance of the specific object.
(19)

The control device according to any one of (1) to (18),
in which the processor is configured to set the range of the analysis based on an imaging environment of the imaging apparatus.
(20)

The control device according to any one of (1) to (19),
in which the processor is configured to update at least one of the information on the size of the specific object or the information on the speed of the specific object, the information being used to set the range of the analysis, based on the information on the distance of the specific object and the result of the analysis.
(21)

The control device according to any one of (1) to (20),
in which the processor is configured to, in a case in which the information on the distance of the specific object is not acquired from the distance measurement device, set the range of the analysis based on the information on the distance of the specific object based on the result of the analysis and at least one of the information on the size of the specific object or the information on the speed of the specific object.
(22)

The control device according to any one of (1) to (21),
in which the processor is configured to update at least one of the information on the size of the specific object or the information on the speed of the specific object, the information being used to set the range of the analysis, based on information acquired from the distance measurement device.
(23)

The control device according to any one of (1) to (22),
in which the processor is configured to acquire correspondence information between a type of the specific object and at least one of the information on the size of the specific object or the information on the speed of the specific object, and acquire at least one of the information on the size of the specific object or the information on the speed of the specific object, the information being used to set the range of the analysis, based on the type of the specific object and the correspondence information.
(24)

The control device according to any one of (1) to (23),
in which the processor is configured to set a position of the range of the analysis based on the result of the analysis.
(25)

The control device according to any one of (1) to (22),
in which the processor is configured to set a position of the range of the analysis based on information acquired from the distance measurement device.
(26)

A control method of an imaging system including an imaging apparatus, a pan-tilt device that is controlled based on a result of analysis of a captured image captured by the imaging apparatus to cause the imaging apparatus to pan and tilt, and a distance measurement device, the control method including:
setting a range of the analysis in the captured image based on information on a distance of a specific object acquired from the distance measurement device and at least one of information on a size of the specific object or information on a speed of the specific object, by a processor of a control device included in the imaging system.
(27)

A non-transitory computer-readable storage medium storing a control program for an imaging system including an imaging apparatus, a pan-tilt device that is controlled based on a result of analysis of a captured image captured by the imaging apparatus to cause the imaging apparatus to pan and tilt, and a distance measurement device, the control program causing a processor of a control device included in the imaging system to execute a process including:
setting a range of the analysis in the captured image based on information on a distance of a specific object acquired from the distance measurement device and at least one of information on a size of the specific object or information on a speed of the specific object.

According to the present invention, it is possible to provide a control device, a control method, and a storage medium capable of improving a tracking performance for a subject.

### BRIEF DESCRIPTION OF THE DRAWINGS

FIG. 1 is a diagram showing an example of a configuration of an imaging system 100 according to an embodiment.

FIG. 2 is a block diagram showing an example of configurations of an optical system and an electrical system of the camera 110.

FIG. 3 is a block diagram showing an example of an imaging range 60 and an analysis range 61 of the camera 110.

FIG. 4 is a flowchart showing a first control example of a pan-tilt device 120 based on the analysis of the captured image.

FIG. 5 is a flowchart showing a second control example of the pan-tilt device 120 based on the analysis of the captured image.

FIG. 6 is a flowchart showing a first setting example of the analysis range.

FIG. 7 is a flowchart showing a second setting example of the analysis range.

FIG. 8 is a flowchart showing a third setting example of the analysis range.

FIG. 9 is a flowchart showing an example of control of a focal length of the camera 110 in association with a change in the analysis range.

FIG. 10 is a diagram showing an example of trimming and displaying a detected subject.

FIG. 11 is a diagram showing an example of releasing the trimming and displaying of the subject.

FIG. 12 is a diagram showing an example of display in a case in which the subject is lost.

FIG. 13 is a flowchart showing a modification example (1) of the second control of the pan-tilt device 120 based on the analysis of the captured image.

FIG. 14 is a flowchart showing a modification example (1) of the third setting of the analysis range.

FIG. 15 is a flowchart showing a modification example (2) of the second control of the pan-tilt device 120 based on the analysis of the captured image.

FIG. 16 is a flowchart showing a modification example (2) of the third setting of the analysis range.

FIG. 17 is a diagram showing an example of a correspondence relationship between a type of the subject and an assumed size and an assumed speed of the subject.

FIG. 18 is a flowchart showing a first shift example of shifting a position of the determined analysis range.

FIG. 19 is a flowchart showing a second shift example of shifting the position of the determined analysis range.

FIG. 20 is a diagram showing an example of a shift of the analysis range 61 with respect to the imaging range 60 of the camera 110.

FIG. 21 is a diagram showing an example of an aspect in which a control program for imaging control is installed in a computer 19 from a storage medium in which the control program is stored.

### DESCRIPTION OF THE PREFERRED EMBODIMENTS

Hereinafter, an example of an embodiment of the present invention will be described with reference to the drawings.

### Imaging System of Embodiment

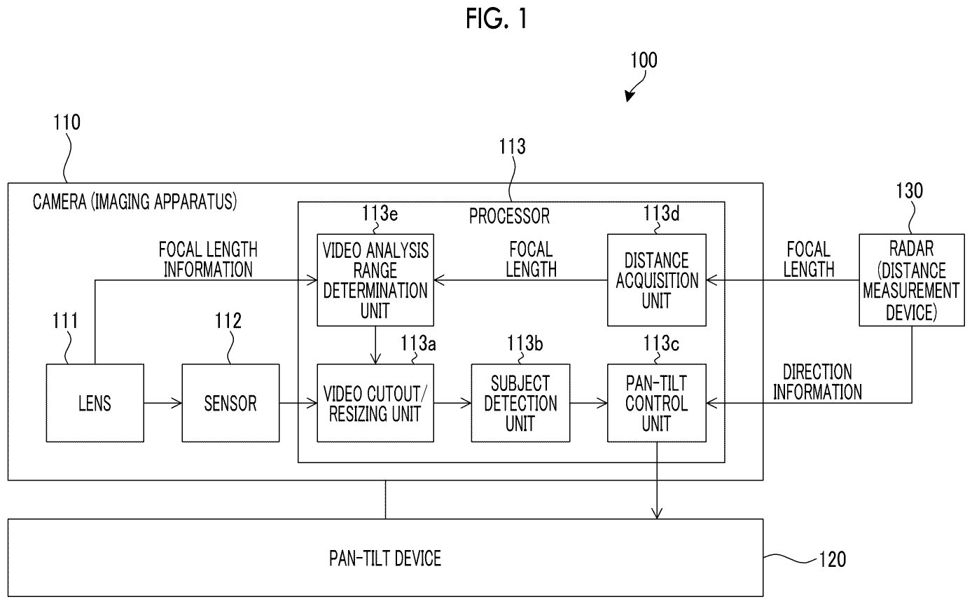

FIG. 1 is a diagram showing an example of a configuration of an imaging system 100 of the embodiment. As shown in FIG. 1, the imaging system 100 comprises a camera 110 that is an example of an “imaging apparatus” according to the present invention, a pan-tilt device 120, and a radar 130 that is an example of a “distance measurement device” according to the present invention. The camera 110 comprises a lens 111, a sensor 112, and a processor 113. The processor 113 comprises a video cutout/resizing unit 113a, a subject detection unit 113b, a pan-tilt control unit 113c, a distance acquisition unit 113d, and a video analysis range determination unit 113e.

The camera 110 is, for example, a camera that monitors a subject such as a drone, a car, or a person. The pan-tilt device 120 is a pan-tilt device that can pan and tilt the camera 110. The camera 110 is attached to the pan-tilt device 120. The camera 110 changes a monitoring direction in association with the panning and tilting of the pan-tilt device 120.

The radar 130 is an external device different from the camera 110 and detects a specific object present in the periphery. The specific object is, for example, a specific subject such as a drone, a car, or a person that the camera 110 is to monitor. The radar 130 is a radar that can emit radio waves, detect a reflected wave thereof, and measure a direction and a distance of a target object. The radar 130 periodically acquires information on a distance of the specific object and information on a direction. The radar 130 is installed, for example, near the camera 110.

The lens 111 of the camera 110 outputs the light captured by the imaging of the camera 110 to the sensor 112. The sensor 112 converts the light into an electric signal to generate image data, and outputs the generated image data to the video cutout/resizing unit 113a. In addition, the lens 111 outputs “focal length information” in imaging information of the camera 110 to the video analysis range determination unit 113e. The focal length information is information on a focal length set in a case of the imaging of the camera 110. A focal length of the camera 110 is variable.

The radar 130 transmits “distance information” on the distance of the detected specific object to the distance acquisition unit 113d of the camera 110. In addition, the radar 130 transmits “direction information” on the direction of the detected specific object to the pan-tilt control unit 113c of the camera 110. The radar 130 transmits the distance information and the direction information to the camera 110 in real time in a command (for example, serial/Transmission Control Protocol (TCP)).

The distance acquisition unit 113d outputs the distance information received from the radar 130 to the video analysis range determination unit 113e. The video analysis range determination unit 113e determines an analysis range in which the video is analyzed in the captured image captured by the camera 110 based on the “focal length information” and the “distance information”. The analysis range is a range that is analyzed to detect the specific subject included in the captured image in the captured image of the camera 110. The video analysis range determination unit 113e outputs the determined analysis range to the video cutout/resizing unit 113a.

The video cutout/resizing unit 113a cuts out the analysis range from the captured image based on the image data from the sensor 112 based on the determined analysis range. In addition, the video cutout/resizing unit 113a resizes the cutout image of the analysis range to display the image, for example, larger. The video cutout/resizing unit 113a outputs an analysis image that is the resized image to the subject detection unit 113b.

The subject detection unit 113b performs, for example, detection processing using machine learning to detect the specific subject from the analysis image. The pan-tilt control unit 113c controls the panning and tilting of the pan-tilt device 120 based on a detection result of the subject detection unit 113b and the direction information from the radar 130.

The camera (imaging apparatus) 110 is an example of a “control device” according to the present invention. The “control device” according to the present invention may be a device other than the camera, for example, the pan-tilt device 120, or may be a personal computer (PC) communicably connected to the camera 110, the pan-tilt device 120, and the radar 130.

In addition, at least any function of the processor 113 may be realized by a processor of a device (for example, a PC communicably connected to the camera 110) outside the camera (imaging apparatus) 110. For example, the pan-tilt control unit 113c may be realized by a processor of an external device. Alternatively, the distance acquisition unit 113d and the video analysis range determination unit 113e may be realized by a processor of an external device.

### Configuration of Optical System and Electrical System of Camera 110

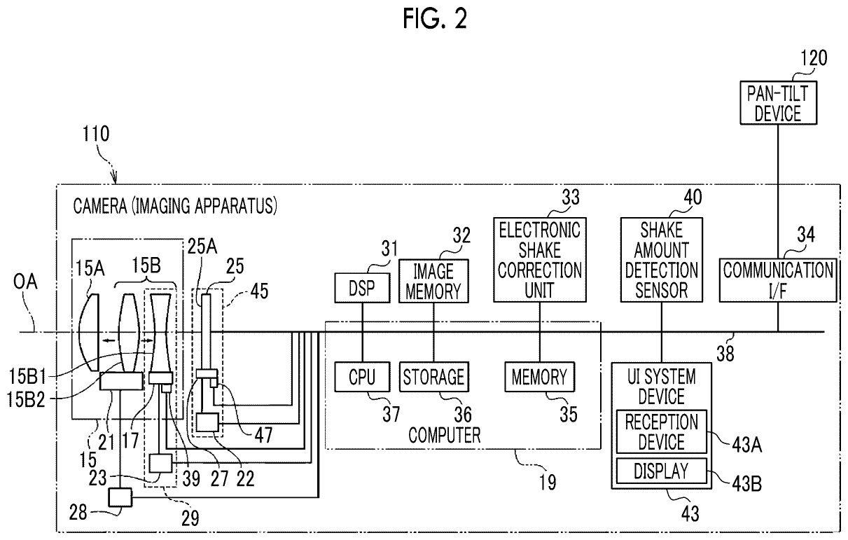

FIG. 2 is a block diagram showing an example of configurations of an optical system and an electrical system of the camera 110. As shown in FIG. 2, the camera 110 comprises an optical system 15 and an imaging element 25. The imaging element 25 is located at a position subsequent to the optical system 15. The optical system 15 comprises an objective lens 15A and a lens group 15B. The objective lens 15A and the lens group 15B are disposed, along an optical axis OA of the optical system 15, over a light-receiving surface 25A side (image side) of the imaging element 25 from a target subject side (object side) in an order of the objective lens 15A and the lens group 15B. The lens group 15B includes an anti-vibration lens 15B1, a focus lens (not illustrated), a zoom lens 15B2, and the like. The zoom lens 15B2 is movably supported along the optical axis OA by a lens actuator 21 described below. The anti-vibration lens 15B1 is movably supported in a direction orthogonal to the optical axis OA by a lens actuator 17 described below.

An increase in a focal length by the zoom lens 15B2 sets the camera 110 on a telephoto side, and thus an angle of view is decreased (imaging range is narrowed). A decrease in the focal length by the zoom lens 15B2 sets the camera 110 on a wide angle side, and thus the angle of view is increased (imaging range is widened).

Various lenses (not illustrated) may be provided as the optical system 15 in addition to the objective lens 15A and the lens group 15B. Furthermore, the optical system 15 may comprise a stop. Positions of the lenses, the lens group, and the stop included in the optical system 15 are not limited. For example, the technique of the present disclosure is also effective for positions different from the positions shown in FIG. 2.

The anti-vibration lens 15B1 is movable in a direction perpendicular to the optical axis OA, and the zoom lens 15B2 is movable along the optical axis OA.

The optical system 15 comprises the lens actuators 17 and 21. The lens actuator 17 causes force that fluctuates in a direction perpendicular to an optical axis of the anti-vibration lens 15B1 to act on the anti-vibration lens 15B1. The lens actuator 17 is controlled by an optical image stabilizer (OIS) driver 23. With the drive of the lens actuator 17 under the control of the OIS driver 23, the position of the anti-vibration lens 15B1 fluctuates in the direction perpendicular to the optical axis OA.

The lens actuator 21 causes force that moves along the optical axis OA of the optical system 15 to act on the zoom lens 15B2. The lens actuator 21 is controlled by a lens driver 28. With the drive of the lens actuator 21 under the control of the lens driver 28, the position of the zoom lens 15B2 moves along the optical axis OA. With the movement of the position of the zoom lens 15B2 along the optical axis OA, the focal length of the camera 110 changes.

In a case in which a contour of the captured image is, for example, a rectangle having a short side in a pitch axis direction and a long side in a yaw axis direction, an angle of view in the pitch axis direction is narrower than an angle of view in the yaw axis direction and narrower than an angle of view of a diagonal line.

With the optical system 15 configured in such a manner, light indicating an imaging region forms an image on the light-receiving surface 25A of the imaging element 25, and the imaging region is imaged by the imaging element 25. The imaging element 25 is an example of the “sensor 112” shown in FIG. 1.

By the way, a vibration applied to the camera 110 includes, in an outdoor situation, a vibration caused by passage of automobiles, a vibration caused by wind, a vibration caused by a road construction, and the like, and includes, in an indoor situation, a vibration caused by an air conditioner operation, a vibration caused by comings and goings of people, and the like. Therefore, in the camera 110, shake occurs due to vibration (hereinafter, also simply referred to as “vibration”) applied to the camera 110.

In the present embodiment, the term “shake” refers to a phenomenon, in the camera 110, in which a target subject image on the light-receiving surface 25A of the imaging element 25 fluctuates due to a change in positional relationship between the optical axis OA and the light-receiving surface 25A. In other words, it can be said that the term “shake” is a phenomenon in which an optical image, which is obtained by the image forming on the light-receiving surface 25A, fluctuates due to a tilt of the optical axis OA caused by the vibration applied to the camera 110. The fluctuation of the optical axis OA means that the optical axis OA is tilted with respect to, for example, a reference axis (for example, the optical axis OA before the shake occurs). Hereinafter, the shake that occurs due to the vibration will be simply referred to as “shake”.

The shake is included in the captured image as a noise component and affects image quality of the captured image. In order to remove the noise component included in the captured image due to the shake, the camera 110 comprises a lens-side shake correction mechanism 29, an imaging element-side shake correction mechanism 45, and an electronic shake correction unit 33, which are used for shake correction.

The lens-side shake correction mechanism 29 and the imaging element-side shake correction mechanism 45 are mechanical shake correction mechanisms. The mechanical shake correction mechanism is a mechanism that corrects the shake by applying, to a shake correction element (for example, anti-vibration lens 15B1 and/or imaging element 25), power generated by a driving source such as a motor (for example, voice coil motor) to move the shake correction element in a direction perpendicular to an optical axis of an imaging optical system.

Specifically, the lens-side shake correction mechanism 29 is a mechanism that corrects the shake by applying, to the anti-vibration lens 15B1, the power generated by the driving source such as the motor (for example, voice coil motor) to move the anti-vibration lens 15B1 in the direction perpendicular to the optical axis of the imaging optical system. The imaging element-side shake correction mechanism 45 is a mechanism that corrects the shake by applying, to the imaging element 25, the power generated by the driving source such as the motor (for example, voice coil motor) to move the imaging element 25 in the direction perpendicular to the optical axis of the imaging optical system. The electronic shake correction unit 33 performs image processing on the captured image based on a shake amount to correct the shake. That is, the shake correction unit (shake correction component) mechanically or electronically corrects the shake using a hardware configuration and/or a software configuration. The mechanical shake correction refers to the shake correction implemented by mechanically moving the shake correction element, such as the anti-vibration lens 15B1 and/or the imaging element 25, using the power generated by the driving source such as the motor (for example, voice coil motor). The electronic shake correction refers to the shake correction implemented by performing, for example, the image processing by a processor.

As shown in FIG. 2 as an example, the lens-side shake correction mechanism 29 comprises the anti-vibration lens 15B1, the lens actuator 17, the OIS driver 23, and a position sensor 39.

As a method of correcting the shake by the lens-side shake correction mechanism 29, various well-known methods can be employed. In the present embodiment, as the method of correcting the shake, a shake correction method is employed in which the anti-vibration lens 15B1 is caused to move based on the shake amount detected by a shake amount detection sensor 40 (described below). Specifically, the anti-vibration lens 15B1 is caused to move, by an amount with which the shake cancels, in a direction of canceling the shake to correct the shake.

The lens actuator 17 is attached to the anti-vibration lens 15B1. The lens actuator 17 is a shift mechanism equipped with the voice coil motor and drives the voice coil motor to cause the anti-vibration lens 15B1 to fluctuate in the direction perpendicular to the optical axis of the anti-vibration lens 15B1. Here, as the lens actuator 17, the shift mechanism equipped with the voice coil motor is employed, but the technique of the present disclosure is not limited thereto. Instead of the voice coil motor, another power source such as a stepping motor or a piezo element may be employed.

The lens actuator 17 is controlled by the OIS driver 23. With the drive of the lens actuator 17 under the control of the OIS driver 23, the position of the anti-vibration lens 15B1 mechanically fluctuates in a two-dimensional plane perpendicular to the optical axis OA.

The position sensor 39 detects a current position of the anti-vibration lens 15B1 and outputs a position signal indicating the detected current position. Here, as an example of the position sensor 39, a device including a Hall element is employed. Here, the current position of the anti-vibration lens 15B1 refers to a current position in an anti-vibration lens two-dimensional plane. The anti-vibration lens two-dimensional plane refers to a two-dimensional plane perpendicular to the optical axis of the anti-vibration lens 15B1. In the present embodiment, the device including the Hall element is employed as an example of the position sensor 39, but the technique of the present disclosure is not limited thereto. Instead of the Hall element, a magnetic sensor, a photo sensor, or the like may be employed.

The lens-side shake correction mechanism 29 causes the anti-vibration lens 15B1 to move along at least one of the direction of the pitch axis or the direction of the yaw axis in an actually imaged range to correct the shake. That is, the lens-side shake correction mechanism 29 causes the anti-vibration lens 15B1 to move in the anti-vibration lens two-dimensional plane by a movement amount corresponding to the shake amount to correct the shake.

The imaging element-side shake correction mechanism 45 comprises the imaging element 25, a body image stabilizer (BIS) driver 22, an imaging element actuator 27, and a position sensor 47.

In the same manner as the method of correcting the shake by the lens-side shake correction mechanism 29, various well-known methods can be employed as the method of correcting the shake by the imaging element-side shake correction mechanism 45. In the present embodiment, as the method of correcting the shake, a shake correction method is employed in which the imaging element 25 is caused to move based on the shake amount detected by the shake amount detection sensor 40. Specifically, the imaging element 25 is caused to move, by an amount with which the shake cancels, in a direction of canceling the shake to correct the shake.

The imaging element actuator 27 is attached to the imaging element 25. The imaging element actuator 27 is a shift mechanism equipped with the voice coil motor and drives the voice coil motor to cause the imaging element 25 to fluctuate in the direction perpendicular to the optical axis of the anti-vibration lens 15B1. Here, as the imaging element actuator 27, the shift mechanism equipped with the voice coil motor is employed, but the technique of the present disclosure is not limited thereto. Instead of the voice coil motor, another power source such as a stepping motor or a piezo element may be employed.

The imaging element actuator 27 is controlled by the BIS driver 22. With the drive of the imaging element actuator 27 under the control of the BIS driver 22, the position of the imaging element 25 mechanically fluctuates in the direction perpendicular to the optical axis OA.

The position sensor 47 detects a current position of the imaging element 25 and outputs a position signal indicating the detected current position. Here, as an example of the position sensor 47, a device including a Hall element is employed. Here, the current position of the imaging element 25 refers to a current position in an imaging element two-dimensional plane. The imaging element two-dimensional plane refers to a two-dimensional plane perpendicular to the optical axis of the anti-vibration lens 15B1. In the present embodiment, the device including the Hall element is employed as an example of the position sensor 47, but the technique of the present disclosure is not limited thereto. Instead of the Hall element, a magnetic sensor, a photo sensor, or the like may be employed.

The camera 110 comprises a computer 19, a digital signal processor (DSP) 31, an image memory 32, the electronic shake correction unit 33, a communication I/F 34, the shake amount detection sensor 40, and a user interface (UI) system device 43. The computer 19 comprises a memory 35, a storage 36, and a central processing unit (CPU) 37. The processor 113 of FIG. 1 is provided in the computer 19 and is, for example, the CPU 37. However, the processor 113 is not limited to the CPU 37, and may be another processor provided in the camera 110.

The imaging element 25, the DSP 31, the image memory 32, the electronic shake correction unit 33, the communication I/F 34, the memory 35, the storage 36, the CPU 37, the shake amount detection sensor 40, and the UI system device 43 are connected to a bus 38. Further, the OIS driver 23 is connected to the bus 38. In the example shown in FIG. 2, one bus is illustrated as the bus 38 for convenience of illustration, but a plurality of buses may be used. The bus 38 may be a serial bus or may be a parallel bus such as a data bus, an address bus, and a control bus.

The memory 35 temporarily stores various types of information, and is used as a work memory. A random access memory (RAM) is exemplified as an example of the memory 35, but the present disclosure is not limited thereto. Another type of storage device may be used. The storage 36 stores various programs for the camera 110. The CPU 37 reads out various programs from the storage 36 and executes the readout various programs on the memory 35 to control the entire camera 110. An example of the storage 36 includes a flash memory, SSD, EEPROM, HDD, or the like. Further, for example, various non-volatile memories such as a magnetoresistive memory and a ferroelectric memory may be used instead of the flash memory or together with the flash memory.

The imaging element 25 is a complementary metal oxide semiconductor (CMOS) image sensor. The imaging element 25 images a target subject at a predetermined frame rate under an instruction of the CPU 37. The term “predetermined frame rate” described herein refers to, for example, several tens of frames/second to several hundreds of frames/second. The imaging element 25 may incorporate a control device (imaging element control device). In this case, the imaging element control device performs detailed control inside the imaging element 25 in response to the imaging instruction output by the CPU 37. Further, the imaging element 25 may image the target subject at the predetermined frame rate under an instruction of the DSP 31. In this case, the imaging element control device performs detailed control inside the imaging element 25 in response to the imaging instruction output by the DSP 31. The DSP 31 may be referred to as an image signal processor (ISP).

The light-receiving surface 25A of the imaging element 25 is formed by a plurality of photosensitive pixels (not illustrated) arranged in a matrix. In the imaging element 25, each photosensitive pixel is exposed, and photoelectric conversion is performed for each photosensitive pixel. A charge obtained by performing the photoelectric conversion for each photosensitive pixel corresponds to an analog imaging signal indicating the target subject. Here, a plurality of photoelectric conversion elements (for example, photoelectric conversion elements in which color filters are disposed) having sensitivity to visible light are employed as the plurality of photosensitive pixels. In the imaging element 25, the photoelectric conversion element having sensitivity to R (red) light (for example, photoelectric conversion element in which an R filter corresponding to R is disposed), the photoelectric conversion element having sensitivity to G (green) light (for example, photoelectric conversion element in which a G filter corresponding to G is disposed), and the photoelectric conversion element having sensitivity to B (blue) light (for example, photoelectric conversion element in which a B filter corresponding to B is disposed) are employed as the plurality of photoelectric conversion elements. In the camera 110, these photosensitive pixels are used to perform the imaging based on the visible light (for example, light on a short wavelength side of about 700 nanometers or less). However, the present embodiment is not limited thereto. The imaging based on infrared light (for example, light on a wavelength side longer than about 700 nanometers) may be performed. In this case, the plurality of photoelectric conversion elements having sensitivity to the infrared light may be used as the plurality of photosensitive pixels. In particular, for example, an InGaAs sensor and/or a simulation of type-II quantum well (T2SL) sensor may be used for short-wavelength infrared (SWIR) imaging.

The imaging element 25 performs signal processing such as analog/digital (A/D) conversion on the analog imaging signal to generate a digital image that is a digital imaging signal. The imaging element 25 is connected to the DSP 31 via the bus 38 and outputs the generated digital image to the DSP 31 in units of frames via the bus 38.

Here, the CMOS image sensor is exemplified for description as an example of the imaging element 25, but the technique of the present disclosure is not limited thereto. A charge coupled device (CCD) image sensor may be employed as the imaging element 25. In this case, the imaging element 25 is connected to the bus 38 via an analog front end (AFE) (not illustrated) that incorporates a CCD driver. The AFE performs the signal processing, such as the A/D conversion, on the analog imaging signal obtained by the imaging element 25 to generate the digital image and output the generated digital image to the DSP 31. The CCD image sensor is driven by the CCD driver incorporated in the AFE. Of course, the CCD driver may be independently provided.

The DSP 31 performs various types of digital signal processing on the digital image. For example, the various types of digital signal processing refer to demosaicing processing, noise removal processing, gradation correction processing, and color correction processing. The DSP 31 outputs the digital image after the digital signal processing to the image memory 32 for each frame. The image memory 32 stores the digital image from the DSP 31.

The shake amount detection sensor 40 is, for example, a device including a gyro sensor, and detects the shake amount of the camera 110. In other words, the shake amount detection sensor 40 detects the shake amount in each of a pair of axial directions. The gyro sensor detects the amount of rotational shake around each of the pitch axis, the yaw axis, and the roll axis (axis parallel to the optical axis OA). The shake amount detection sensor 40 detects the shake amount of the camera 110 by converting the amount of rotational shake around the pitch axis and the amount of rotational shake around the yaw axis, which are detected by the gyro sensor, into the shake amount in a two-dimensional plane parallel to the pitch axis and the yaw axis.

Here, the gyro sensor is described as an example of the shake amount detection sensor 40, but this is merely an example, and the shake amount detection sensor 40 may be an acceleration sensor. The acceleration sensor detects the shake amount in a two-dimensional plane parallel to the pitch axis and the yaw axis. The shake amount detection sensor 40 outputs the detected shake amount to the CPU 37.

Further, although the form example is shown in which the shake amount is detected by a physical sensor called the shake amount detection sensor 40, the technique of the present disclosure is not limited thereto. For example, a movement vector obtained by comparing preceding and succeeding captured images in time series, which are stored in the image memory 32, may be used as the shake amount. Further, the shake amount to be finally used may be derived based on the shake amount detected by the physical sensor and the movement vector obtained by the image processing.

The CPU 37 acquires the shake amount detected by the shake amount detection sensor 40 and controls the lens-side shake correction mechanism 29, the imaging element-side shake correction mechanism 45, and the electronic shake correction unit 33 based on the acquired shake amount. The shake amount detected by the shake amount detection sensor 40 is used for the shake correction by each of the lens-side shake correction mechanism 29 and the electronic shake correction unit 33.

The electronic shake correction unit 33 is a device including an application specific integrated circuit (ASIC). The electronic shake correction unit 33 performs the image processing on the captured image in the image memory 32 based on the shake amount detected by the shake amount detection sensor 40 to correct the shake.

Here, the device including the ASIC is exemplified as the electronic shake correction unit 33, but the technique of the present disclosure is not limited thereto. For example, a device including a field programmable gate array (FPGA) or a programmable logic device (PLD) may be used. Further, for example, the electronic shake correction unit 33 may be a device including a plurality of ASICs, FPGAs, and PLDs. Further, a computer including a CPU, a storage, and a memory may be employed as the electronic shake correction unit 33. The number of CPUs may be singular or plural. Further, the electronic shake correction unit 33 may be implemented by a combination of a hardware configuration and a software configuration.

The communication I/F 34 is, for example, a network interface, and controls transmission of various types of information to and from the pan-tilt device 120 via a network. The network is, for example, a wide area network (WAN) or a local area network (LAN), such as the Internet. The communication I/F 34 performs communication between the camera 110 and the pan-tilt device 120.

Here, the pan-tilt device 120 performs the panning and tilting in response to the control instruction (for example, the pan control value and the tilt control value) output from the camera 110 via the communication I/F 34, but may perform the panning and tilting to track the tracking target subject based on the metadata output from the camera 110 in addition to the control instruction from the camera 110 or instead of the control instruction from the camera 110. As a result, the pan-tilt device 120 can obtain information on the subject with higher accuracy, and can improve the tracking performance of the subject.

For example, in a case in which the pan-tilt device 120 outputs a metadata acquisition command to the camera 110, the camera 110 outputs the metadata to the pan-tilt device 120 via the communication I/F 34.

The metadata includes, for example, information indicating a size or a position of the subject. In addition, the metadata may further include information indicating a speed of the subject. These pieces of information can be used for controlling the panning and tilting (pan/tilt) of the pan-tilt device 120.

In addition, the metadata may include information indicating a type of the subject. The information indicating the type of the subject can be used by the pan-tilt device 120 to distinguish the subject (for example, to distinguish a human from a drone).

In addition, the metadata may include information indicating a unique ID of the subject. The information indicating the unique ID of the subject can be used by the pan-tilt device 120 to identify the individual of the subject in a case in which there are the same type of subjects.

In addition, the metadata may include a timestamp. The timestamp is a time corresponding to the frame in which the subject detection is performed. The timestamp can be used by the pan-tilt device 120 to calculate the speed of the subject even in a case in which the time taken for the image analysis in the camera 110 is not constant.

In addition, the metadata may include a score. The score is information indicating reliability of the subject detection result in the camera 110, and can be used to improve robustness in the tracking of the subject by the panning and tilting of the pan-tilt device 120.

A timing at which the metadata is output from the camera 110 to the pan-tilt device 120 is, for example, a timing at which a state (position, size, speed, lost state) of the subject is changed. A dead band may be provided in the determination of the change in the state (position, size, speed, lost state) of the subject.

In addition, the metadata may be output from the camera 110 to the pan-tilt device 120 by being embedded in a video stream output from the camera 110. As a result, since the metadata is associated with the timestamp of the video stream, the pan-tilt device 120 can calculate the speed of the subject even in a case in which the time taken for the image analysis in the camera 110 is not constant even if the timestamp is not included in the metadata.

The UI system device 43 comprises a reception device 43A and a display 43B. The reception device 43A is, for example, a hard key, a touch panel, and the like, and receives various instructions from a user. The CPU 37 acquires various instructions received by the reception device 43A and operates in response to the acquired instructions.

The display 43B displays various types of information under the control of the CPU 37. Examples of the various types of information displayed on the display 43B include a content of various instructions received by the reception device 43A and the captured image.

### Imaging Range and Analysis Range of Camera 110

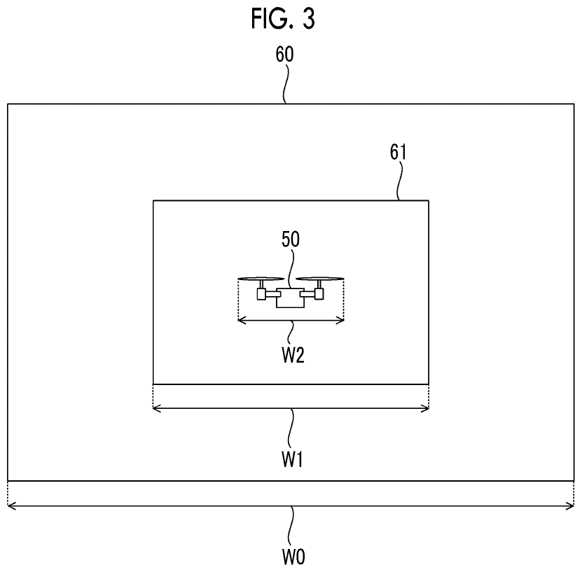

FIG. 3 is a block diagram showing an example of the imaging range 60 and the analysis range 61 of the camera 110. As shown in FIG. 3, in the imaging range 60 captured by the camera 110, a predetermined size range for performing the analysis of the moving object (for example, the drone 50) that is the tracking target is set as the analysis range 61.

The imaging range 60 is a range corresponding to an entire region of the image generated by the imaging element 25 (the sensor 112 of FIG. 1) of FIG. 2. The analysis range 61 is a range set by the processor 113 based on, for example, a distance to the drone 50, a size of the drone 50, a movement speed of the drone 50, and the like. In this example, the analysis range 61 is set to a substantially central portion of the imaging range 60.

### First Control Example of Pan-Tilt Device 120 Based on Analysis of Captured Image

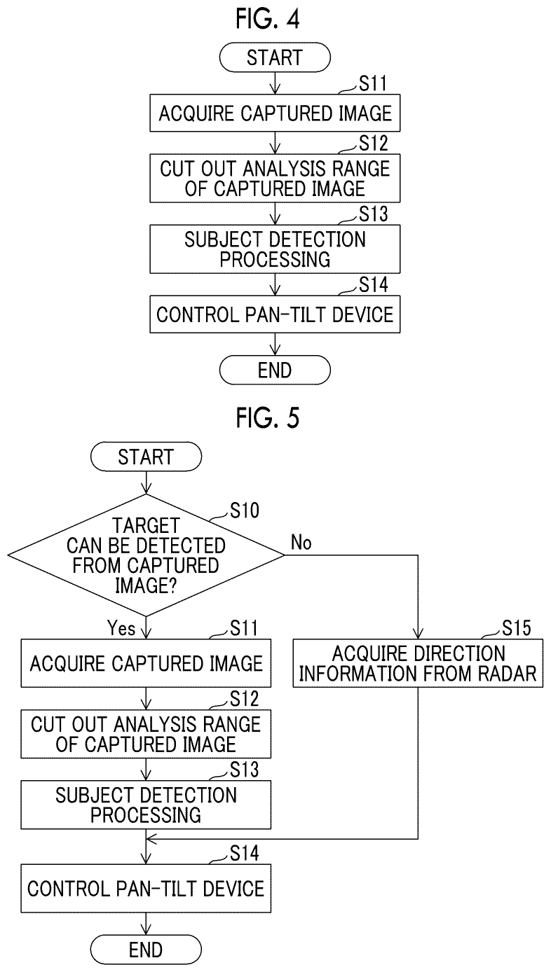

FIG. 4 is a flowchart showing a first control example of the pan-tilt device 120 based on the analysis of the captured image.

The processor 113 of the camera 110 acquires the captured image of the camera 110 generated by the sensor 112 (step S11).

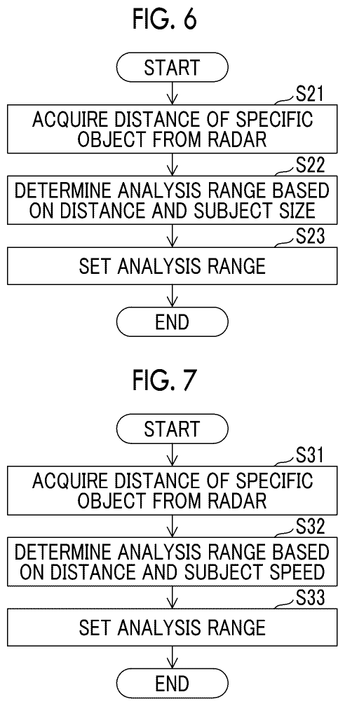

Next, the processor 113 cuts out the analysis range for detecting the specific subject (for example, the drone 50) in the captured image acquired in step S11 (step S12). The analysis range is a range set in processing (for example, processing of FIG. 6 described below) of determining the analysis range.

Next, the processor 113 analyzes the image of the analysis range cut out in step S12 and performs, for example, subject detection processing using machine learning for detecting the drone 50 (step S13).

Next, the processor 113 controls the panning and tilting of the pan-tilt device 120 such that, for example, the position of the drone 50 detected in the analysis range comes to the center position of the analysis range (step S14). In this example, the pan-tilt device 120 is panned and tilted by manual control or the like such that the drone 50 as the tracking target comes to the substantially center of the analysis range. The processor 113 repeatedly executes the main processing for each frame of the image to be captured.

### Second Control Example of Pan-Tilt Device 120 Based on Analysis of Captured Image

FIG. 5 is a flowchart showing a second control example of the pan-tilt device 120 based on the analysis of the captured image.

First, the processor 113 of the camera 110 determines whether the subject as the tracking target can be detected from the captured image of the camera 110 in the previous subject detection processing (step S10). The condition of whether the target can be detected is an example of a “first condition” of the present invention.

In a case in which the target can be detected in step S10 (step S10: Yes), the processor 113 proceeds to step S11 and executes each processing from step S11 to step S14. The processing from step S11 to step S14 is the same as each processing from step S11 to step S14 described in FIG. 4, and thus the description thereof will be omitted.

On the other hand, in a case in which the target cannot be detected in step S10 (step S10: No), the processor 113 acquires the direction information on the specific object detected by the radar 130 from the radar 130 (step S15). The condition in a case in which the target cannot be detected is an example of a “first condition” of the present invention.

Next, the processor 113 proceeds to step S14 and controls the pan-tilt device 120 based on the direction information on the specific object acquired from the radar 130. The processor 113 repeatedly executes the main processing for each frame of the image to be captured.

### First Setting Example of Analysis Range

FIG. 6 is a flowchart showing a first setting example of the analysis range.

The processor 113 of the camera 110 acquires the distance information on the distance of the specific object detected by the radar 130 from the radar 130 (step S21).

Next, the processor 113 determines the analysis range based on the “distance information” of the specific object and the “size information” on the size of the specific subject (for example, the drone 50) acquired in step S21 (step S22). The size of the subject may be a size set in advance according to the type of the subject, or may be a size assumed and set by the user for each subject. The size may be an approximate value that is assumed in a representative manner, and is not an exact value.

For example, in the imaging range 60, the analysis range 61, and the subject (drone 50) shown in FIG. 3, in a case in which a distance from the camera 110 to the drone 50 is denoted by ObjectD (m), a size of the drone 50 is denoted by ObjectW2 (m), a limit performance of the video analysis of the camera 110 (a ratio of the size of the drone 50 that can be detected with respect to the analysis range 61) is denoted by DetectRate (%), a focal length of the camera 110 is denoted by ShootingD (mm), a size of the sensor 112 is denoted by SensorW3 (mm), and a number of horizontal pixels of the imaging range 60 is denoted by ImageW0, the number of pixels DetectW of the analysis range 61 in the horizontal direction is obtained by the following expression.

$$DetectW = ImageW 0 / ( ObjectD / ShootingD \times SensorW 3 ) \times ( ObjectW 2 / ( DetectRate / 100 ) )$$

(ObjectD/ShootingD×SensorW3) corresponds to a range (m) of the entire video at the subject position. (ObjectW2/(DetectRate/100)) corresponds to an analysis range (m) at the subject position. That is, the processor 113 determines the number of pixels DetectW of the analysis range 61 in the horizontal direction from the distance to the drone 50, the size of the drone 50, and the limit performance of the camera 110 of how small the drone 50 can be detected in the video analysis. The limit performance of the camera 110 is a limit (upper limit) at which the drone 50 cannot be detected in a case in which the analysis range 61 is wider. For example, the limit performance is about 5% to 10% of the ratio of the drone 50 to the analysis range 61.

Next, the processor 113 sets the analysis range determined in step S22 in, for example, the memory 35 of the computer 19 (step S23). The processor 113 repeatedly executes the main processing at a period longer than the frame period of the image to be captured. The main processing may be repeated at the frame period.

### Second Setting Example of Analysis Range

FIG. 7 is a flowchart showing a second setting example of the analysis range.

The processor 113 of the camera 110 acquires the distance information on the distance of the specific object detected by the radar 130 from the radar 130 (step S31).

Next, the processor 113 determines the analysis range based on the “distance information” of the specific object and the “speed information” on the speed of the movement of the specific subject (for example, the drone 50) acquired in step S31 (step S32). The speed of the movement of the subject may be a speed set in advance according to the type of the subject, or may be a speed assumed and set by the user for each subject. For example, the speed may be the assumed maximum speed of the subject.

For example, in the imaging range 60, the analysis range 61, and the subject (drone 50) shown in FIG. 3, in a case in which a distance from the camera 110 to the drone 50 is denoted by ObjectD (m), a speed of the drone 50 is denoted by ObjectSpeed (m/s), a frame rate of the video analysis of the camera 110 is denoted by FPS (fps), a focal length of the camera 110 is denoted by ShootingD (mm), a size of the sensor 112 is denoted by SensorW3 (mm), and a number of horizontal pixels of the imaging range 60 is denoted by ImageW0, the number of pixels DetectW of the analysis range 61 in the horizontal direction is obtained by the following expression.

$$DetectW = ImageW 0 / ( ObjectD / ShootingD \times SensorW 3 ) \times ( ObjectSpeed / FPS \times 2 )$$

(ObjectSpeed/FPS×2) is the analysis range (m) at the subject position. That is, the processor 113 determines the number of pixels DetectW of the analysis range 61 in the horizontal direction from the distance to the drone 50, the speed of the drone 50, and the frame rate (reciprocal of processing time) of the video analysis. In a case in which the drone 50 moves out of the analysis range 61 during one frame, the drone 50 cannot be continuously tracked, so the analysis range 61 is obtained by using a distance from a center of the video in which the drone 50 moves during one frame to an end of the angle of view as a limit range. The limit range is a limit (lower limit) at which the drone 50 cannot be continuously tracked in a case in which the analysis range 61 is narrower.

Next, the processor 113 sets the analysis range determined in step S32 in, for example, the memory 35 of the computer 19 (step S33). The processor 113 repeatedly executes the main processing at a period longer than the frame period of the image to be captured. The main processing may be repeated at the frame period.

As described above, the camera 110 (control device) of the embodiment sets the analysis range 61 in the imaging range 60 of the camera 110 based on the information on the distance of the specific object detected by the radar 130 and at least one of the information on the size of the moving object (drone 50) that is the tracking target or the information on the speed.

According to this configuration, the analysis range 61 having a size suitable for the analysis of the video can be set according to the detection state of the subject that is the tracking target. Therefore, even a small and fast-moving subject such as the drone 50 can be accurately detected, and the tracking performance for the subject can be improved.

In addition, with the camera 110, the pan-tilt device 120 can be controlled for panning and tilting based on the result of the detection processing of the subject in the set analysis range 61. Therefore, the panning and tilting direction of the pan-tilt device 120 can be appropriately adjusted, and the tracking performance for the subject can be further improved.

### Third Setting Example of Analysis Range

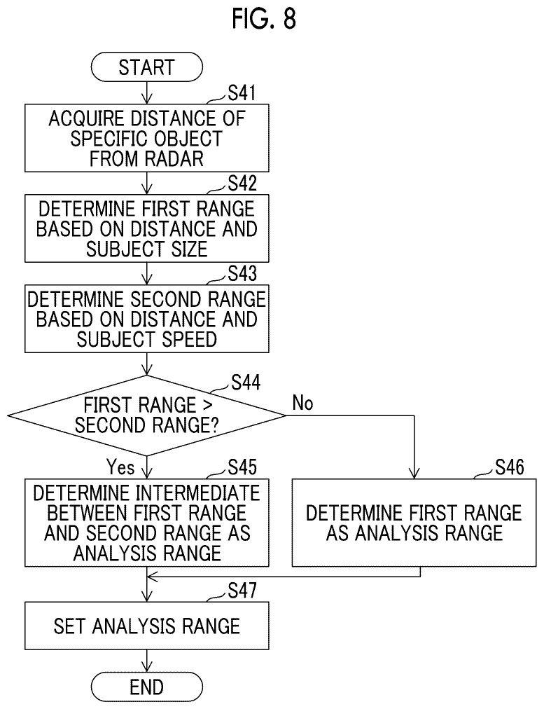

FIG. 8 is a flowchart showing a third setting example of the analysis range.

The processor 113 of the camera 110 acquires the distance information on the distance of the specific object detected by the radar 130 from the radar 130 (step S41).

Next, the processor 113 determines the first range as the first candidate analysis range based on the “distance information” of the specific object and the “size information” on the size of the specific subject (for example, the drone 50) acquired in step S41 (step S42). The size of the subject is as described in the first setting example.

Next, the processor 113 determines the second range as the second candidate analysis range based on the “distance information” of the specific object and the “speed information” on the speed of the movement of the specific subject acquired in step S41 (step S43). The speed of the movement of the subject is as described in the second setting example.

Next, the processor 113 compares the first range determined in step S42 and the second range determined in step S43, and determines whether the first range is wider than the second range (step S44).

In step S44, in a case in which the first range is wider than the second range (step S44: Yes), the processor 113 determines a range that is narrower than the first range and wider than the second range, for example, a range having an intermediate width between the first range and the second range, as the analysis range for detecting the specific subject (step S45). However, the range determined as the analysis range is not limited to the range having the intermediate width, and may be a range from the second range to the first range.

Next, the processor 113 sets the determined analysis range in, for example, the memory 35 of the computer 19 (step S47).

On the other hand, in step S44, in a case in which the first range is not wider than the second range (step S44: No), the processor 113 determines the first range as the analysis range (step S46). The processor 113 proceeds to step S47 to set the determined analysis range. That is, in a case in which the first range is not wider than the second range, the processor 113 determines the analysis range by prioritizing the restriction (first range) on the size of the specific subject.

As described above, by setting the analysis range by comparing and considering the first range determined based on the size information of the subject and the limit of the detection performance of the camera 110 and the second range determined based on the speed information of the subject and the processing time of the video analysis of the camera 110, the analysis range suitable for the performance of the camera 110 can be set.

### Control of Focal Length Based on Analysis Range

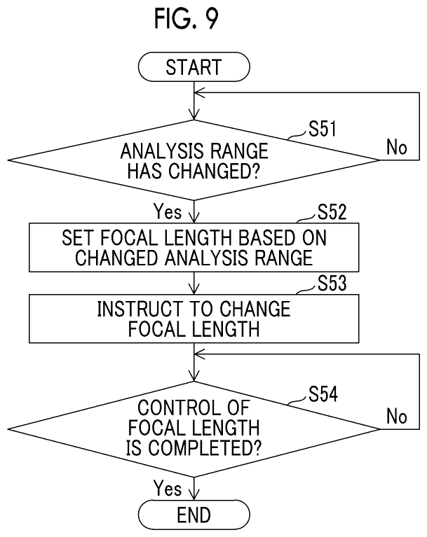

FIG. 9 is a flowchart showing an example of control of the focal length of the camera 110 in association with a change in the analysis range.

The processor 113 of the camera 110 determines whether the set analysis range has changed (step S51). For example, it is determined whether the analysis range has changed as compared with the range set in the previous analysis range setting processing. In a case in which the analysis range has not changed (step S51: No), the processor 113 repeats the processing of step S51.

In step S51, in a case in which the analysis range has changed (step S51: Yes), the processor 113 sets the focal length of the camera 110 based on the changed analysis range (step S52). The processor 113 sets the focal length such that the imaging range 60 (refer to FIG. 3) of the camera 110 is wider (for example, 1.5 times) than the changed analysis range 61.

Next, the processor 113 instructs the lens driver 28 (refer to FIG. 2) to change the focal length to the focal length set in step S52 (step S53).

Next, the processor 113 determines whether the control of the focal length is completed (step S54). In a case in which the control of the focal length is not completed (step S54: No), the processor 113 repeats the processing of step S54. In a case in which the control of the focal length is completed (step S54: Yes), the processor 113 ends the main processing.

As described above, by changing the focal length of the camera 110 in response to the change in the analysis range, the analysis range more suitable for the camera 110 can be set. The main processing is repeatedly executed in parallel with the processing of setting the analysis range. However, since the control of the focal length takes time, the main processing is repeatedly executed for each of the plurality of frames.

### Display of Specific Subject

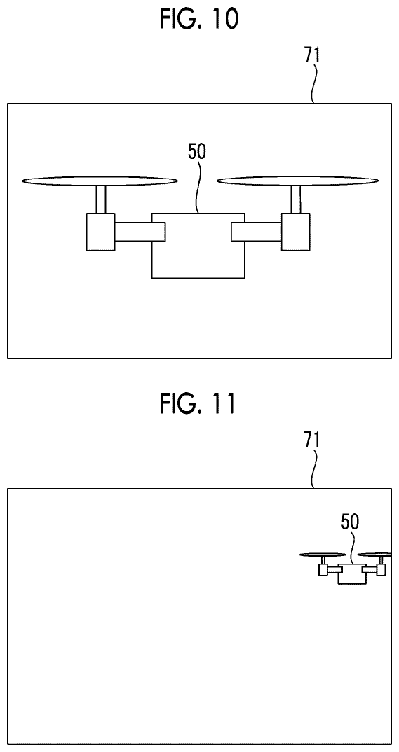

FIG. 10 is a diagram showing an example of trimming and displaying the detected subject. In a case in which the specific subject (for example, the drone 50) is detected by the analysis of the captured image, the processor 113 of the camera 110 may trim the image of the detected drone 50 and resize the image to be displayed larger on a display screen 71 of the display device. The display device that displays the image may be a display device provided in the camera 110 or may be an external display device. As a result, it is possible to further easily see the detected specific subject.

FIG. 11 is a diagram showing an example of releasing the trimming and displaying of the subject. In a case in which the drone 50 detected by the analysis of the captured image is not detected, the processor 113 may release the trimming and displaying of the image of the drone 50 that has been trimmed and displayed to be displayed on the display screen 71 of the display device. For example, in a case in which the drone 50 moves out of the analysis range and the drone 50 cannot be detected, the processor 113 releases the trimming and displaying of the drone 50. As a result, the angle of view can be widened to easily detect the lost drone 50.

### Notification in Case of Losing Subject

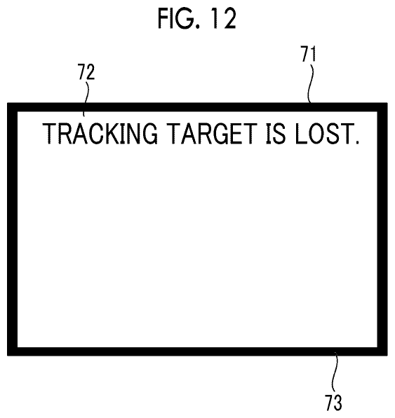

FIG. 12 is a diagram showing an example of display in a case in which the subject is lost. In a case in which the specific subject (for example, the drone 50) cannot be detected in the analysis of the analysis range, the processor 113 notifies the user of this fact. The notification is, for example, superimposing information indicating that the drone 50 is lost on the image displayed on the display device. For example, as shown in FIG. 12, in a case in which the drone 50 that has been detected moves out of the analysis range and is lost in the middle, the processor 113 displays a message 72 such as “The tracking target is lost” on the display screen 71 of the display device to perform a notification to the user. In addition, the processor 113 may perform a notification to the user by covering the image on which the message 72 is displayed with, for example, a red frame 73. Further, as in the case described in FIG. 11, the processor 113 may release the trimming of the drone 50.

### Modification Example (1) of Control of Pan-Tilt Device 120 Based on Analysis of Captured Image

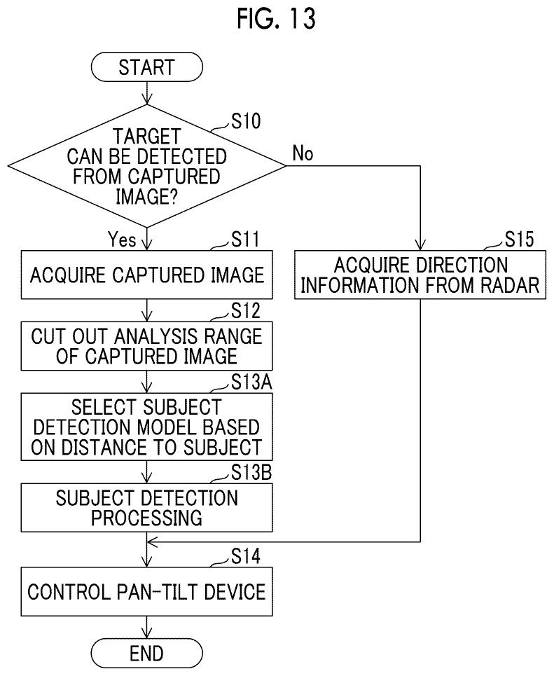

FIG. 13 is a flowchart showing a modification example (1) of the second control (FIG. 5) of the pan-tilt device 120 based on the analysis of the captured image.

As shown in FIG. 13, the processing from step S10 to step S12 is the same as each processing from step S10 to step S12 of the second control example described in FIG. 5.

Next, the processor 113 selects the subject detection model used to detect the subject (drone 50) based on the distance between the subject in the analysis range and the camera 110 (step S13A). The distance between the subject and the camera 110 is, for example, the distance information acquired from the radar 130. The subject detection model is a plurality of analysis modes prepared in advance to detect the subject, and a plurality of modes having different processing loads and accuracy of the analysis are prepared. The subject detection model is, for example, a machine learning model that detects the subject by machine learning. For example, as the distance between the subject and the camera 110 is longer, the machine learning model having a high processing load and high accuracy is selected. As a result, the detection performance of the subject can be maintained high even in a case in which the distance to the subject is long.

The processing from step S13B to step S15 of FIG. 13 is the same as each processing from step S13 to step S15 of the second control example described in FIG. 5, and thus the description thereof will be omitted.

### Modification Example (1) of Setting of Analysis Range

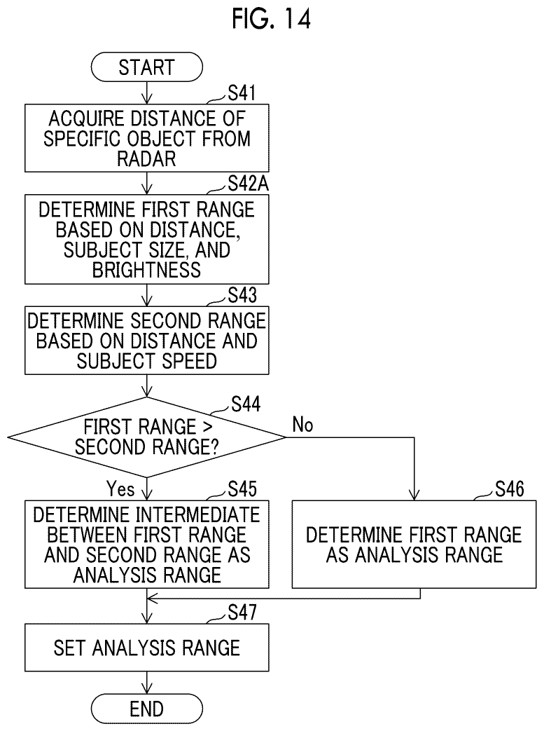

FIG. 14 is a flowchart showing a modification example (1) of the third setting (FIG. 8) of the analysis range.

As shown in FIG. 14, the processing of step S41 is the same as the processing of step S41 of the third setting example described in FIG. 8.

Next, the processor 113 determines the first range as the first candidate analysis range based on the “distance information” of the specific object, the “size information” on the size of the specific subject (for example, the drone 50), and “brightness information” on the imaging environment of the camera 110 acquired in step S41 (step S42A). For example, the first range set as the analysis range is determined to be narrower as the subject to be captured is darker. The brightness information is acquired, for example, by measuring the brightness with the automatic exposure function of the camera 110. As a result, for example, the analysis accuracy can be improved even in a dark environment such as a day with bad weather or at night.

The processing from step S43 to step S47 of FIG. 14 is the same as each processing from step S43 to step S47 of the third setting example described in FIG. 8, and thus the description thereof will be omitted.

In the present example, the first range is determined to include the “brightness information” in step S42A, but the present disclosure is not limited to this. For example, the first range may be determined without including the “brightness information” in step S42A, and the analysis range may be determined in step S45 or step S46, and then the analysis range may be corrected according to the “brightness information”.

### Modification Example (2) of Control of Pan-tilt Device 120 Based on Analysis of Captured Image

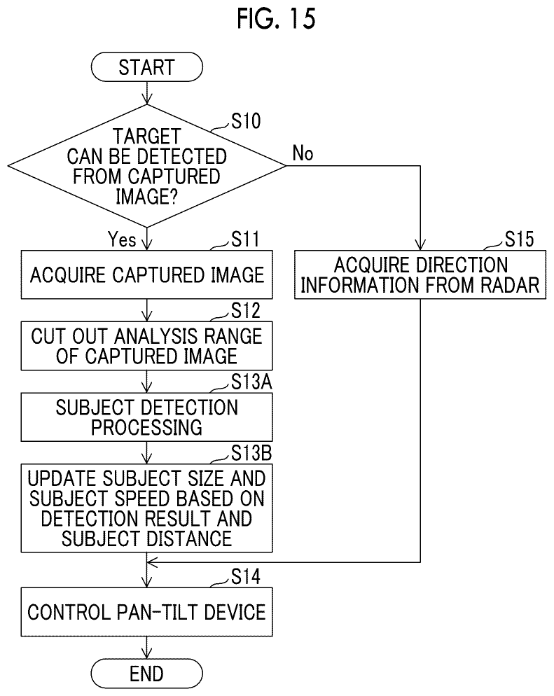

FIG. 15 is a flowchart showing a modification example (2) of the second control (FIG. 5) of the pan-tilt device 120 based on the analysis of the captured image.

As shown in FIG. 15, the processing from step S10 to step S13A is the same as each processing from step S10 to step S13 of the second control example described in FIG. 5.

Next, the processor 113 updates the “size information” on the size of the subject set so far and the “speed information” on the movement speed of the subject based on the detection result of the subject detected in the detection processing of step S13A and the distance from the camera 110 to the subject (step S13B). The assumed “size information” and “speed information” set at the start of the tracking of the subject are updated to the “size information” and “speed information” calculated based on the detection result of the subject detected sequentially after the start of the tracking and the distance to the subject. As a result, the analysis range of the subject can be further optimized.

The processing of step S14 and step S15 of FIG. 15 is the same as the processing of step S14 and step S15 of the second control example described in FIG. 5, and thus the description thereof will be omitted. In the present modification example, the size and the speed of the subject are updated based on the detection result and the subject distance, but the present disclosure is not limited to this. For example, the user may be able to update the size and the speed of the subject by an input operation.

### Modification Example (2) of Setting of Analysis Range

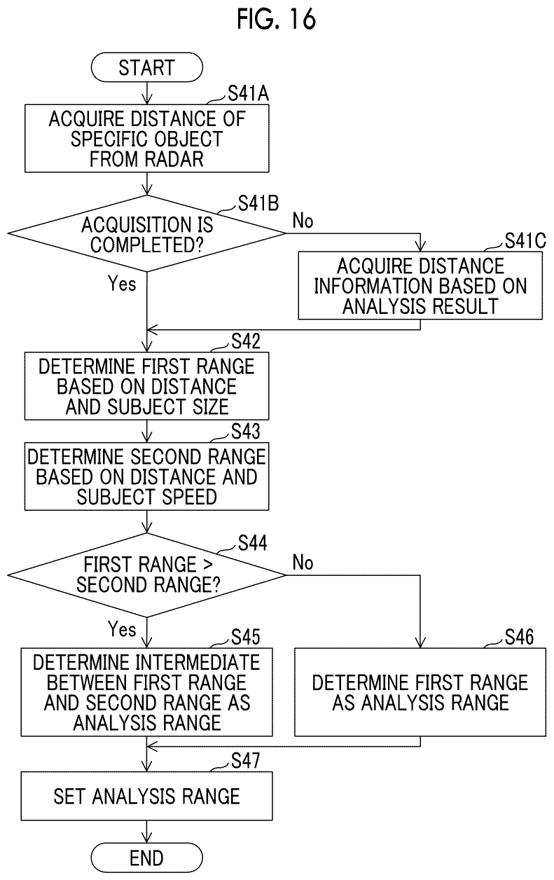

FIG. 16 is a flowchart showing a modification example (2) of the third setting (FIG. 8) of the analysis range.

As shown in FIG. 16, in the present modification example, the processor 113 determines whether the distance information on the distance of the specific object can be acquired after performing processing of acquiring the distance information from the radar 130 (step S41A) (step S41B).

In a case in which the distance information can be acquired in step S41B (step S41B: Yes), the processor 113 proceeds to step S42 as it is. On the other hand, in a case in which the distance information cannot be acquired from the radar 130 in step S41B (step S41B: No), the processor 113 proceeds to step S42 after acquiring the distance information based on the analysis result (step S41C). The case in which the distance information cannot be acquired from the radar 130 is a case in which the radar 130 cannot detect the specific object (for example, the drone 50) (for example, the specific object is lost).

The distance information based on the analysis result is, for example, distance information to the subject calculated based on the analysis result (for example, the size of the image region in which the subject is detected) of analyzing the analysis range in the subject detection processing, the focal length (angle of view) of the camera 110, and the “size information” on the size of the subject.

The processing from step S42 to step S47 of FIG. 16 is the same as each processing from step S42 to step S47 of the third setting example described in FIG. 8. According to the present modification example, for example, even in a case in which the radar 130 cannot detect the specific object, the distance information based on the analysis result can be used, so that the analysis range of the subject can be appropriately set.

### Acquisition of Size and Speed of Subject

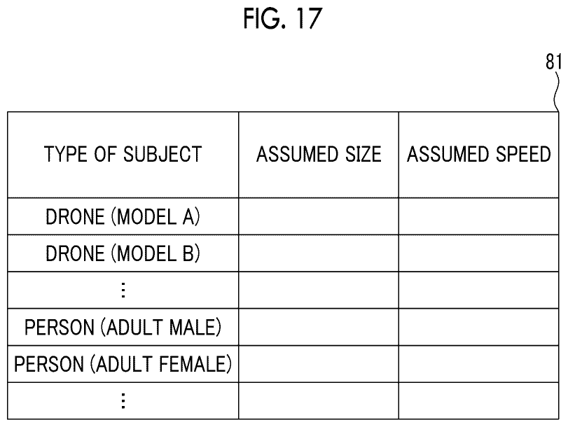

FIG. 17 is a diagram showing an example of a correspondence relationship between a type of the subject and an assumed size and an assumed speed of the subject. As shown in FIG. 17, the camera 110 may hold, for example, in the memory 35 of the computer 19, correspondence information 81 between the assumed type of the subject and the assumed size and speed of the subject in advance.

For example, in a case of detecting and tracking the specific subject, the user performs a selection operation of the type of the subject (for example, the drone (model A)) from the correspondence information 81. The processor 113 acquires the assumed size and the assumed speed associated with the selected type of the subject from the correspondence information 81, and sets the assumed size and the assumed speed as the size and the speed of the subject used for setting the analysis range of the captured image.

As a result, the size and the speed of the subject can be efficiently set. The setting of the type of the subject is not limited to a case in which the user performs the selection operation. For example, the processor 113 may specify the type of the subject by analyzing the captured image of the camera 110 and set the specified type of the subject.

### First Shift Example of Analysis Range

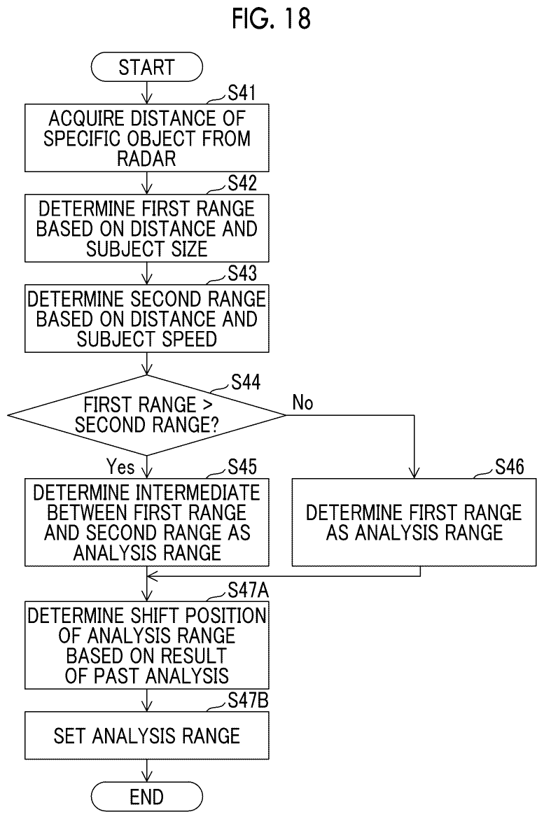

FIG. 18 is a flowchart showing a first shift example of shifting a position of the determined analysis range.

As shown in FIG. 18, the processing from step S41 to step S46 is the same as each processing from step S41 to step S46 of the third setting example described in FIG. 8.

In a case in which the analysis range is determined in step S45 or step S46, the processor 113 determines the shift position of the analysis range based on the result of the past analysis (step S47A). The determination based on the result of the past analysis is, for example, based on a position in the analysis range at which the detected subject is detected in the detection processing of the subject in the previous analysis range.

The determination of the shift position of the analysis range is to shift the analysis range such that the detected subject comes to, for example, a substantially center of the analysis range, or to shift the analysis range such that the subject comes to a position slightly advanced in the movement direction of the subject from the center of the analysis range. As a result, the subject can be prevented from moving out of the analysis range, and the subject having a high movement speed can be tracked.

Next, the processor 113 sets the determined analysis range in, for example, the memory 35 of the computer 19 (step S47B).

### Second Shift Example of Analysis Range

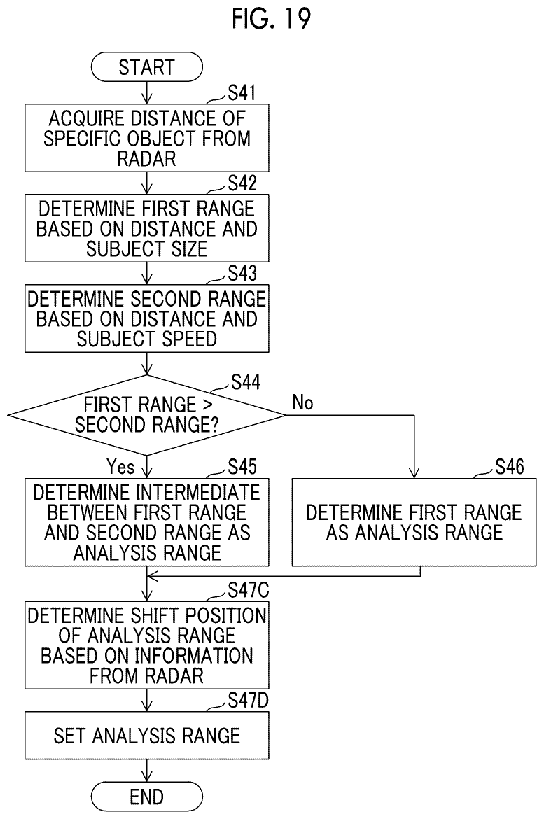

FIG. 19 is a flowchart showing a second shift example of shifting the position of the determined analysis range.

As shown in FIG. 19, the processing from step S41 to step S46 is the same as each processing from step S41 to step S46 of the third setting example described in FIG. 8.

In a case in which the analysis range is determined in step S45 or step S46, the processor 113 determines the shift position of the analysis range based on the direction information from the radar 130 (step S47C). The direction information from the radar 130 is “direction information” on the direction of the specific object detected by the radar 130.

The determination of the shift position of the analysis range is to shift the analysis range such that the subject comes to a substantially center of the analysis range, as in the first shift example of FIG. 18. As a result, as in the first shift example, the subject having a high movement speed can be tracked.

Next, the processor 113 sets the determined analysis range in, for example, the memory 35 of the computer 19 (step S47D).

### Shift Example of Analysis Range 61 with Respect to Imaging Range 60

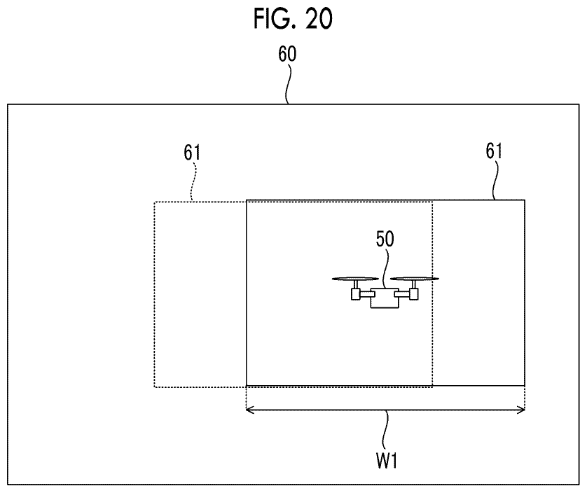

FIG. 20 is a diagram showing an example of a shift of the analysis range 61 with respect to the imaging range 60 of the camera 110. As shown in FIG. 20, it is assumed that, as a result of the detection processing of the subject, the subject (drone 50) that is the tracking target is detected at a right position in the analysis range 61 set at the center of the imaging range 60, which is shown by a broken line. In this case, the processor 113 shifts the analysis range 61 to the right direction such that the detected drone 50 comes to a substantially center of the analysis range 61, and determines the shift position of the analysis range at a position of the analysis range 61 shown by a solid line.

### Storage Medium for Control Program

In each imaging control described above, the control program of each embodiment is stored in the storage 36 of the computer 19, and the CPU 37 of the computer 19 executes the control program in the memory 35, but the technology of the present disclosure is not limited to this.

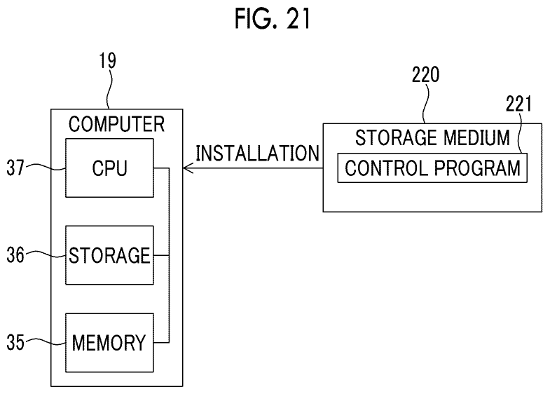

FIG. 21 is a diagram showing an example of an aspect in which a control program for imaging control is installed in a computer 19 of a camera (imaging apparatus) 110 from a storage medium in which the control program is stored. As shown in FIG. 21 as an example, a control program 221 may be stored in a storage medium 220 which is a non-transitory storage medium. In a case of the example shown in FIG. 21, the control program 221 stored in the storage medium 220 is installed in the computer 19, and the CPU 37 executes each processing described above in accordance with the control program 221.

Although various embodiments have been described above, it is needless to say that the present invention is not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2023-138033) filed on Aug. 28, 2023 and Japanese Patent Application (JP 2023-178219) filed on Oct. 16, 2023, the contents of which are incorporated in the present application by reference.

### EXPLANATION OF REFERENCES

15: optical system
15A: objective lens
15B: lens group
15B1: anti-vibration lens
15B2: zoom lens
17, 21: lens actuator
19: computer
22: BIS driver
23: OIS driver
25: imaging element
25A: light-receiving surface
27: imaging element actuator
28: lens driver
29, 45: correction mechanism
31: DSP
32: image memory
33: electronic shake correction unit
34: communication I/F
35: memory
36: storage
37: CPU
38: bus
39, 47: position sensor
40: shake amount detection sensor
43: UI system device
43A: reception device
43B: display
50: drone
60: imaging range
61: analysis range
71: display screen
72: message
73: red frame
81: correspondence information
100: imaging system
110: camera
111: lens
112: sensor
113: processor
113a: video cutout/resizing unit
113b: subject detection unit
113c: pan-tilt control unit
113d: distance acquisition unit
113e: video analysis range determination unit
120: pan-tilt device
130: radar
220: storage medium
221: control program

What is claimed is:

1. A control device that is included in an imaging system including an imaging apparatus, a pan-tilt device that is controlled based on a result of analysis of a captured image captured by the imaging apparatus to cause the imaging apparatus to pan and tilt, and a distance measurement device, the control device comprising:
a processor,
wherein the processor is configured to set a range of the analysis for detecting a specific object in the captured image based on information on a distance of the specific object acquired from the distance measurement device and at least one of information on a size of the specific object or information on a speed of the specific object.

2. The control device according to claim 1,
wherein the specific object is a specific subject included in the captured image.

3. The control device according to claim 1,
wherein the processor is configured to perform the analysis.

4. The control device according to claim 1,
wherein the processor is configured to control the pan-tilt device based on the result of the analysis.

5. The control device according to claim 1,
wherein the distance measurement device is a device that acquires information on a direction.

6. The control device according to claim 1,
wherein the distance measurement device is a radar.

7. The control device according to claim 5,
wherein the processor is configured to:
control the pan-tilt device based on a detection result of the specific object by the analysis; and
control the pan-tilt device based on the information on the direction in a case in which the detection result satisfies a first condition.

8. The control device according to claim 7,
wherein the first condition is a condition regarding whether the specific object is detected.

9. The control device according to claim 8,
wherein the first condition is a condition in which the specific object is not detected.

10. The control device according to claim 1,
wherein the processor is configured to set the range of the analysis based on a first range in the captured image based on the information on the distance of the specific object and the information on the size of the specific object and a second range in the captured image based on the information on the distance of the specific object and the information on the speed of the specific object.

11. The control device according to claim 10,
wherein the processor is configured to set a range narrower than the first range and wider than the second range as the range of the analysis.

12. The control device according to claim 11,
wherein the processor is configured to set the first range as the range of the analysis in a case in which the first range is narrower than the second range.

13. The control device according to claim 1,
wherein a focal length of the imaging apparatus is variable, and
the processor is configured to control the focal length based on the range of the analysis.

14. The control device according to claim 13,
wherein the processor is configured to control the focal length such that an imaging range of the imaging apparatus is wider than the range of the analysis.

15. The control device according to claim 1,
wherein the processor is configured to display, on a display device, an image obtained by trimming the captured image based on the result of the analysis.

16. The control device according to claim 15,
wherein the processor is configured to, in a case in which the specific object is not detected by the analysis, release the trimming and display the captured image on the display device.

17. The control device according to claim 1,
wherein the processor is configured to perform a notification to a user in a case in which the specific object is not detected by the analysis.

18. The control device according to claim 1,
wherein the processor is configured to select a mode of the analysis from among a plurality of analysis modes based on the information on the distance of the specific object.

19. The control device according to claim 1,
wherein the processor is configured to set the range of the analysis based on an imaging environment of the imaging apparatus.

20. The control device according to claim 1,
wherein the processor is configured to update at least one of the information on the size of the specific object or the information on the speed of the specific object, the information being used to set the range of the analysis, based on the information on the distance of the specific object and the result of the analysis.

21. The control device according to claim 1,
wherein the processor is configured to, in a case in which the information on the distance of the specific object is not acquired from the distance measurement device, set the range of the analysis based on the information on the distance of the specific object based on the result of the analysis and at least one of the information on the size of the specific object or the information on the speed of the specific object.

22. The control device according to claim 1,
wherein the processor is configured to update at least one of the information on the size of the specific object or the information on the speed of the specific object, the information being used to set the range of the analysis, based on information acquired from the distance measurement device.

23. The control device according to claim 1,
wherein the processor is configured to acquire correspondence information between a type of the specific object and at least one of the information on the size of the specific object or the information on the speed of the specific object, and acquire at least one of the information on the size of the specific object or the information on the speed of the specific object, the information being used to set the range of the analysis, based on the type of the specific object and the correspondence information.

24. The control device according to claim 1,
wherein the processor is configured to set a position of the range of the analysis based on the result of the analysis.

25. The control device according to claim 1,
wherein the processor is configured to set a position of the range of the analysis based on information acquired from the distance measurement device.

26. A control method of an imaging system including an imaging apparatus, a pan-tilt device that is controlled based on a result of analysis of a captured image captured by the imaging apparatus to cause the imaging apparatus to pan and tilt, and a distance measurement device, the control method comprising:
setting a range of the analysis for detecting a specific object in the captured image based on information on a distance of the specific object acquired from the distance measurement device and at least one of information on a size of the specific object or information on a speed of the specific object, by a processor of a control device included in the imaging system.

27. A non-transitory computer-readable storage medium storing a control program for an imaging system including an imaging apparatus, a pan-tilt device that is controlled based on a result of analysis of a captured image captured by the imaging apparatus to cause the imaging apparatus to pan and tilt, and a distance measurement device, the control program causing a processor of a control device included in the imaging system to execute a process comprising:
setting a range of the analysis for detecting a specific object in the captured image based on information on a distance of the specific object acquired from the distance measurement device and at least one of information on a size of the specific object or information on a speed of the specific object.
